(19) United States
(12) Patent Application Publication
(10) Pub. No.: US 2018/0342930 A1
(43) Pub. Date: Nov. 29, 2018

(54) METHOD AND APPARATUS FOR CHARGING BATTERIES IN PORTABLE DEVICES

(71) Applicant: Brian Roberts, Evergreen, CO (US)

(72) Inventor: Brian Roberts, Evergreen, CO (US)

(21) Appl. No.: 15/987,032

(22) Filed: May 23, 2018

Related U.S. Application Data
(60) Provisional application No. 62/510,807, filed on May 25, 2017.

(51) Int. Cl. H02K 7/18; A63H 33/26; A63H 1/00

(52) U.S. Cl. CPC H02K 7/1853; A63H 29/08; A63H 1/00; A63H 33/26

(57) ABSTRACT

A method and apparatus for charging a battery with a finger actuated low mass spinner electromagnetically converts the mechanical spinning energy to the desired battery charging voltage. The charger may be a self-contained portable battery charger unit for use with any of multiple devices containing respective batteries, or it may be a permanent part of such a device. The spinner may be a modified fidget spinner to which a shaft or axle is fixedly attached to rotate about that axis with the spinner and has one or more permanent magnets secured for rotation therewith. Alternatively the spinner may be more like the fidget spinner, without an axle rotating therewith, and having magnets on its rotating arms. In either case, the magnetic fields of the rotating magnets induce voltage in one or more induction coils to generate a battery charging voltage.

### CROSS REFERENCE TO RELATED APPLICATIONS

The present application claims priority from and is a non-provisional application of U.S. Provisional Application No. 62/510,807 entitled “Electric Generator For Battery Charging And The Like”, filed May 25, 2017, the disclosure of which is hereby incorporated by reference in its entirety.

### BACKGROUND

### Technical Field

The present invention pertains generally to hand operated electricity generators and, more particularly, to such generators that can be held and used to charge a battery in portable devices such as, for example, mobile phones.

### Discussion of the Prior Art

The present invention provides an improvement over the charger disclosed in U.S. Pat. No. 8,344,693 (Budziszek et al), the entire disclosure of which is incorporated by reference herein. That patent discloses a battery-powered mobile device (e.g., a mobile phone) and an attached electric generator configured to charge the mobile phone battery. The generator includes a rotor secured to a wall of the device and a stator projecting from the device, the stator having a flat exposed contact surface. The rotor can be rotated relative to the stator about an axis which is perpendicular to the contact surface and passes through the center of mass of the device. A voltage regulator circuit is connected between the generator and the device battery so that, when the apparatus is placed on a support surface (e.g., a table) with the stator contact surface frictionally engaging the support surface, and the device is spun about its axis, the generator produces a voltage which, via the voltage regulator circuit, recharges the device battery. There are disadvantages associated with this arrangement. First, the user of the device may not have access to a flat support surface when a charge is needed. Second, the mass of the spun device limits the number of rotations resulting from a given manually applied rotation-inducing force, thereby resulting in a relatively small amount of charge generated per force application. Third, spinning a device, such as a mobile phone, which is not designed to be spun, is awkward, at best.

The present invention is also an improvement over the devices disclosed in U. S. Patent Application Pub. No. 2004/0204180 (Liao), U.S. Pat. No. 7,289,831 (Trozzi) and U.S. Pat. No. 7,608,933 (Yang), the entire disclosures in which are incorporated by reference herein. These devices utilize manual actuation of a crank or a pull string to rotate a rotor disposed in, or in adjacent proximity to, a mobile phone for the purpose of charging the phone battery. The manual actuation requires two hands of the user, one hand to actuate the crank or pull string and the other hand to hold the mobile phone. It often happens that a user is in a situation where only one hand is free, thereby rendering these devices unusable. Moreover, actuation of these devices typically requires purposeful intent to charge the mobile phone battery which usually occurs after the battery has fully or almost fully discharged, thereby requiring considerable manual actuation time to re-charge the battery before the phone is effectively functional. It is desirable to provide a manually actuable battery charger that permits a user to enjoyably actuate the charger at random times to keep the battery at a functional charge level, while permitting the user to do so while engaged in some other activity.

### Terminology

It is to be understood that, unless otherwise stated or contextually evident, as used herein:

The term “top” is used for convenience to refer to the orientation of a battery charger or other device described herein and not intended to otherwise limit the structures described and claimed.

The term “axially”, etc., refers to the axis about which spinners described herein are caused to rotate.

The term “radial” refers to dimensions extending perpendicularly from the rotation axis of the spinner devices used in embodiments of the present invention.

The terms “angular”, “rotational”, etc., unless otherwise stated refer to the rotation dimension about the rotation axis.

### SUMMARY OF THE INVENTION

In a general sense, the invention pertains to a self-contained portable battery charger in which mechanical energy applied from a finger-actuated low mass spinner is converted to a voltage that can be used, for example, to supply a charging current to a battery in a device such as a mobile phone. The spinner may be a modified fidget spinner having a plurality of arms radially extending from its rotation axis and to which a shaft or axle is fixedly attached to rotate about that axis with the spinner. One or more permanent magnets attached to and rotatable with the shaft are positioned relative to one or more inductive coils (i.e., coils of electrically conductive wire) so as to electromagnetically induce alternating current in the coils for use in charging a battery in the mobile phone or similar device.

The spinner is preferably mounted on an external surface of a wall of the charger housing or other enclosure, with the rotatable shaft extending axially from the spinner into the housing through a suitable opening or bearing. The permanent magnets and coils may be located within the housing in positional relationship to permit the moving magnetic field of the rotated magnets to pass through and induce current in the coil(s). Voltage regulator circuitry may be provided for converting the induced current to a voltage appropriate for charging specified battery types.

Alternatively, the permanent magnets may be located outside the walls of the housing on the radially extending arms of the spinner, with the coils located inside the housing. The housing wall in this alternative embodiment is nonmagnetic to assure transmission of the rotating magnetic fields through to the coil(s).

When the spinner is spun by a flicking-type angularly directed force applied to one or more of its arms by a person's finger(s), the attached magnet(s) rotate so that the magnetic field extending around the top and bottom of the coils constantly changes between a north and a south pole. This rotational movement of the magnetic field results in an alternating emf (i.e., a voltage) being induced into the coil. The magnitude of the electromagnetic induction in each coil is directly proportional to the magnetic flux density, the length of coil wire (i.e., the number of loops in the wire and the coil diameter), the number of coils and magnets, and the rate or velocity at which the magnetic field changes within the coil wire.

In accordance with another aspect of the invention a battery charger comprises a finger-actuable spinner unit having plural radially extending arms configured to rotate about an axis in response to angularly directed finger flicks applied to one or more of said arms, and at least one inductive coil of electrically conductive wire. At least one permanent magnet is secured to the spinner unit and configured to rotate therewith about the axis, the magnet being positioned relative to the coil so as to electromagnetically induce an AC voltage in the coil at an amplitude that varies with the speed of rotation of the spinner unit. A voltage regulator circuit converts the induced AC voltage to a substantially constant DC voltage for charging a battery.

In still another aspect, the invention comprises a method of charging a battery by: manually applying finger flick forces to radially extending arms of a finger-actuable spinner unit to rotate the spinner about an axis; rotating at least one permanent magnet with the spinner unit to electromagnetically induce an AC voltage in at least one inductive coil; rectifying and filtering the induced AC voltage to provide a DC charging voltage; and applying the DC charging voltage to charge a battery.

The above and still further features and advantages of the present invention will become apparent upon consideration of the definitions, descriptions and descriptive figures of specific embodiments thereof set forth herein. In the detailed description below, like reference numerals in the various figures are utilized to designate like components and elements, and like terms are used to refer to similar or corresponding elements in the several embodiments. While these descriptions go into specific details of the invention, it should be understood that variations may and do exist and would be apparent to those skilled in the art in view of the following description.

### BRIEF DESCRIPTION OF THE DRAWINGS

FIG. 1 is a schematic diagram illustrating the principles of the present invention.

FIG. 2 is an elevation view showing the back of a mobile phone with a manually actuable spinner mounted thereon according to one embodiment of the invention.

FIG. 3 is a perspective view of the mobile phone and spinner of FIG. 2 diagrammatically illustrating a user actuating the spinner.

FIG. 4 is a partial side view of an embodiment of electromagnetic charging components that may be used in the embodiment of FIG. 2.

FIG. 5 is an electrical schematic diagram of a voltage regulator circuit that may be used with the electromagnetic charging components of FIG. 4 to provide a charging voltage for the battery in the mobile phone of FIG. 2.

FIG. 6 is a top plan view of an alternative spinner having magnets on it arms that may be used in another embodiment of the invention.

FIG. 7 is an electrical schematic diagram of electromagnetic charging components that may be used with the spinner embodiment of FIG. 6.

### DESCRIPTION OF THE PREFERRED EMBODIMENTS

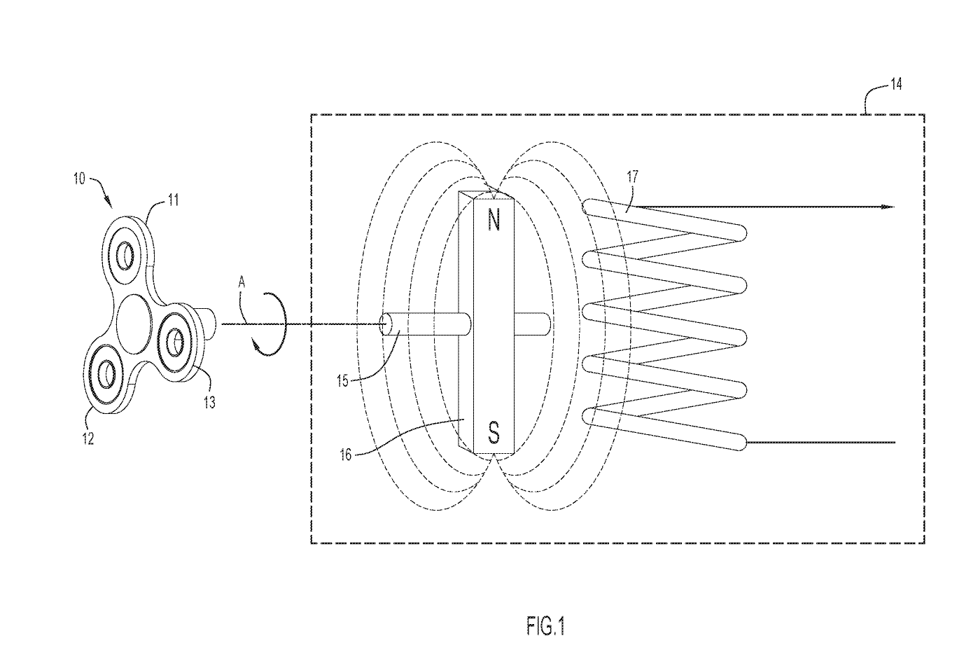

In a general sense, the present invention pertains to a self-contained portable battery charger wherein mechanical energy applied from a finger-actuated low mass spinner is converted to a voltage that can be used to supply a charging current to a battery. A schematic representation on this arrangement is shown in FIG. 1 to which reference is now made. A modified fidget spinner 10 is of the type generally known and sold as a fidget spinner, one version of which is disclosed in U.S. Pat. No. 9,914,063 (McCoskery), the entire disclosure in which is incorporated herein by reference. The spinner 10 has a plurality of arms, for example three arms 11, 12 and 13, radially extending from its rotation axis A and to which a shaft or axle 15 is fixedly attached, by adhesive, friction fit, diametric pins, etc., to rotate about axis A with the spinner. A permanent magnet 16 attached to and rotatable with the shaft 15 is positioned relative to a coil or coils 17 of electrically conductive wire so as to electromagnetically induce alternating current in the coil(s) for use in charging a battery in the manner described below.

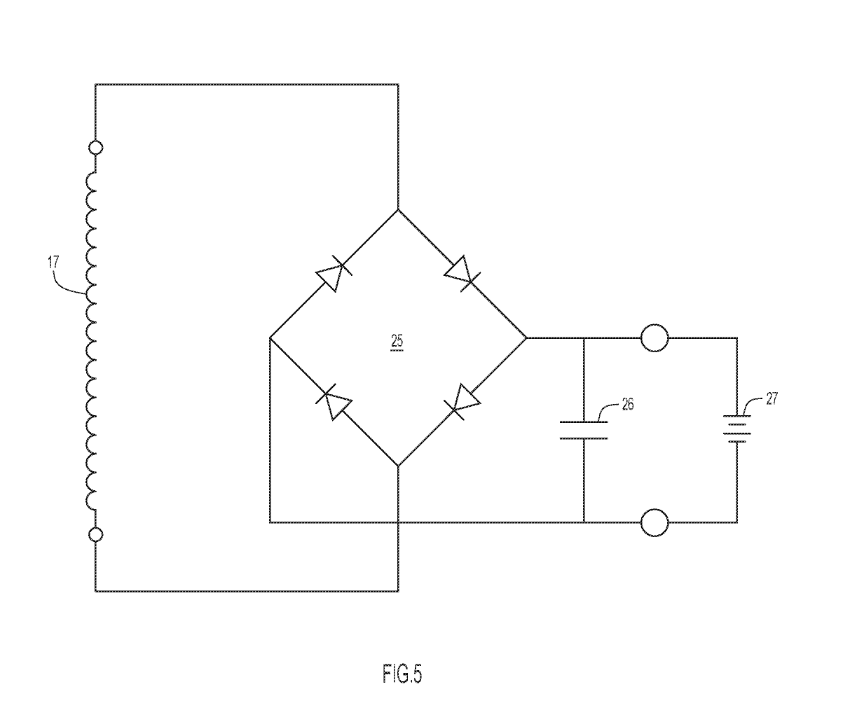

A charger housing or casing 14 is typically provided and defines an enclosure, the spinner being mounted externally thereof on a wall of the housing. The rotating shaft 15 extends from the spinner into the housing enclosure 14 through appropriate and conventional bushings, or the like. The permanent magnet 16 and coil(s) 17 are located within the housing enclosure 14 in positional relationship to permit the magnetic field of the magnet to pass through the coil(s) as shown. Also located in the housing enclosure is appropriate voltage regulator circuitry (FIG. 5, not shown in FIG. 1) for converting the induced current through coil 17 to a voltage appropriate for charging specified battery types.

If the charger shown in FIG. 1 is a separate unit from the device containing the battery to be charged, connection of the charging voltage to the battery to be charged depends on the device containing the battery. For example, the charger may have a cable extending therefrom and terminating in a USB plug suitable for connecting to the USB receptacle of a mobile phone, or the like. Alternatively, the charger may have a permanent USB plug extending therefrom for directly engaging a USB receptacle at the device to be charged, thereby eliminating the need for a cable. As further alternative, the charger may be structurally attached to a wall of the device (e.g., a mobile phone) containing the battery to be charged, and the coil(s) 17 and the voltage regulator circuit may be located within that device.

When the spinner is spun by a flicking-type force applied angularly to one or more of its arms by a person's finger, the shaft 15 and attached magnet 16 rotate so that the magnetic field around the top and bottom of coil(s) 17 constantly changes between a north pole N and a south pole S. This rotational movement of the magnetic field results in an alternating emf (i.e., a voltage) being induced in the coil(s). The magnitude of the electromagnetic induction (i.e., the amplitude of the induced voltage) is a function of the magnetic flux density, the length of coil wire (i.e., the number of loops in the wire and the coil diameter), the number of coils and the rotational speed of the spinner (i.e., the rate or velocity at which the magnetic field changes within the coil wire). It will be understood that more than one coil 17 may be provided and more than one permanent magnet may be provided to increase the emf generated per revolution of spinner 10.

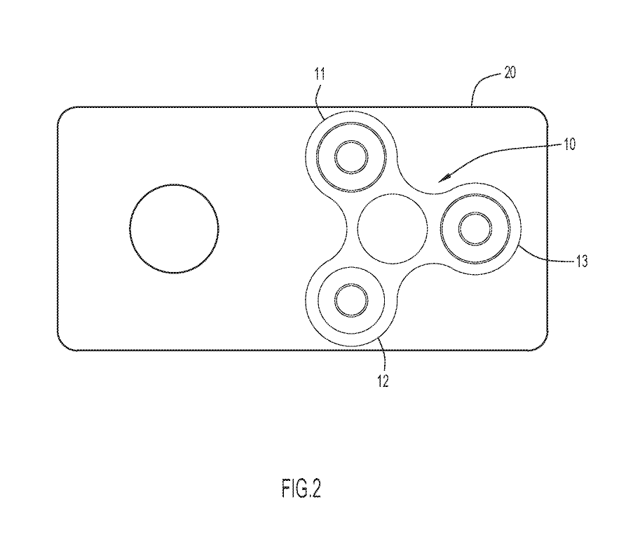

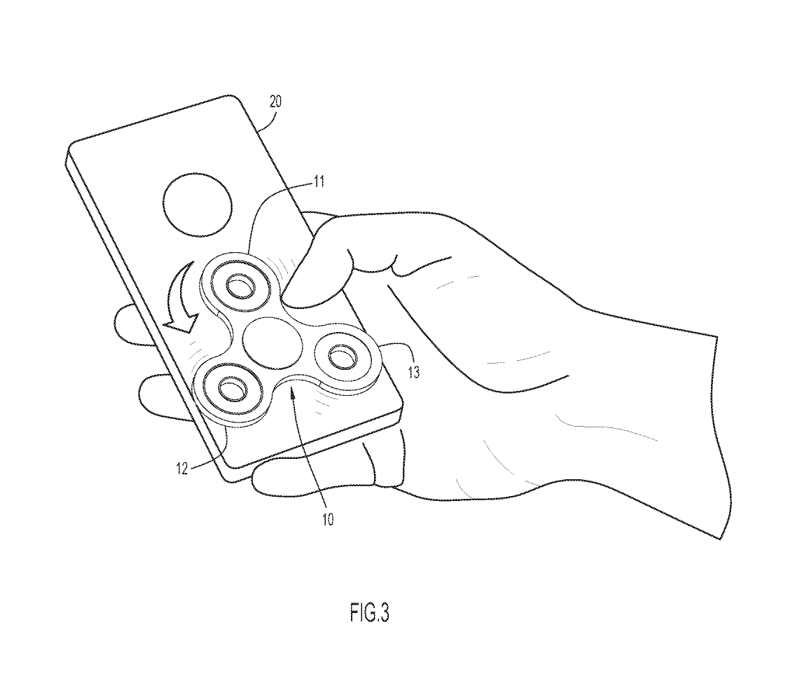

An embodiment of the invention in which the charger is structurally attached to a wall of a mobile phone containing the battery to be charged is illustrated in FIGS. 2 and 3. The spinner 10 is secured externally, on the back or rear wall of a mobile phone 20, it being understood that the coil(s) and electrical circuitry are located proximate the battery inside the enclosure defined by the phone housing. As shown in FIG. 3, the phone 20 may be held in the palm of the hand of a user so that that spinner can be rapidly and continuously rotated by multiple successive flicks of the user's thumb applied angularly to the arms 11, 12, 13 of the spinner. Alternatively, the user may hold the phone 20 in one hand and apply successive flicks with a finger or fingers of his/her other hand. As a further alternative the phone 20 may be placed on a surface, or secured in place (e.g., on the user's belt by clip or loop, in a holster, etc.), and successive flicks may be applied by the user's fingers of either hand. Importantly, in any orientation of the phone, the user can apply the flicks at any time, as a conscious effort to charge the phone battery, or while performing some other unrelated activity, or as a release of nervous energy or stress, etc. Whatever the reason, the spinning maintains the phone battery sufficiently charged for ready use in substantially any environment or location without the need for a nearby AC voltage receptacle.

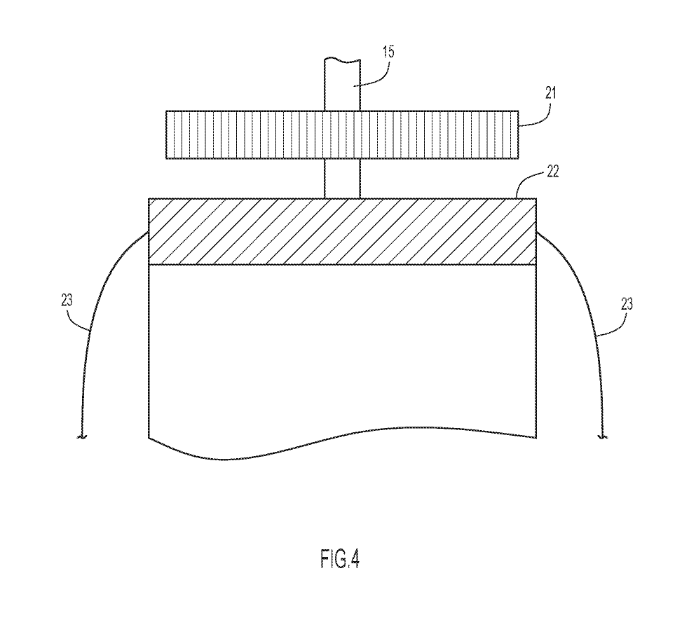

Referring to FIG. 4, axle 15, which is connected for rotation with the spinner 10 as described above, may have a disc 21, such as a flywheel, concentrically secured thereto for rotations therewith. The disc has one or more magnets (not shown in FIG. 4) secured thereto in proximity to one or more inductive coils 22 from which wiring 23 conducts current to a suitable voltage regulator as described.

A conventional voltage regulator circuit is illustrated in FIG. 5 and may be electrically connected across the inductive coil(s) 17 (or coils 22 of FIG. 4). The circuit includes a full wave rectifier diode bridge 25 having its input terminals connected across coil(s) 17. The rectified output voltage of the bridge is connected across a filtering capacitor 26 in order to provide a relatively constant DC output voltage substantially equal to the peak AC voltage of the emf induced in coil(s) 17. The output terminals of the regulator circuit are connected across the battery 27 to be charged. The regulator circuit is preferably physically located with the coil(s) 17 in a separate housing 14 for charger or in the housing of the device containing the battery to be charged.

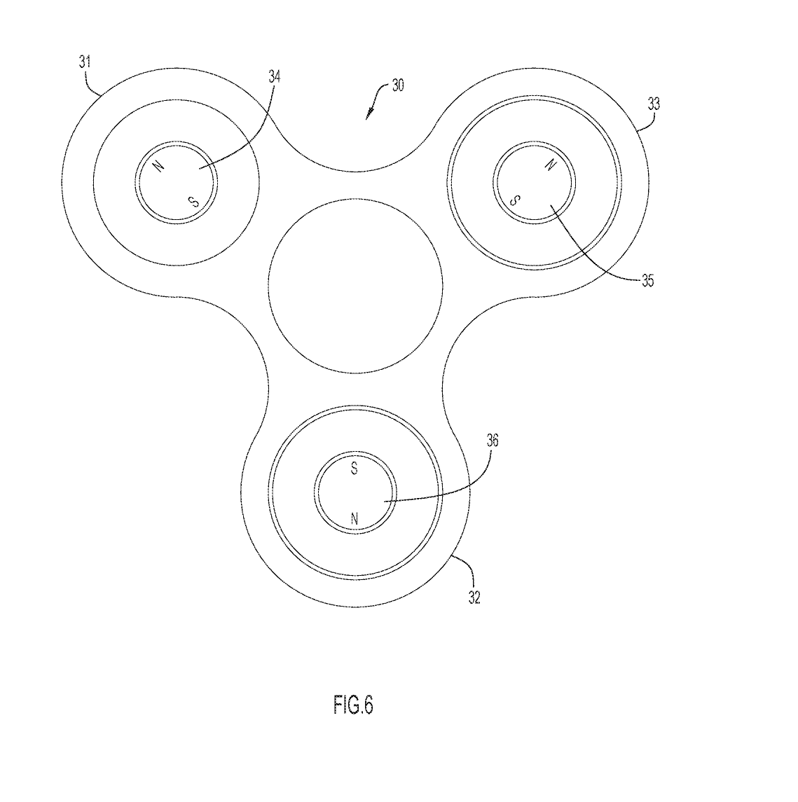

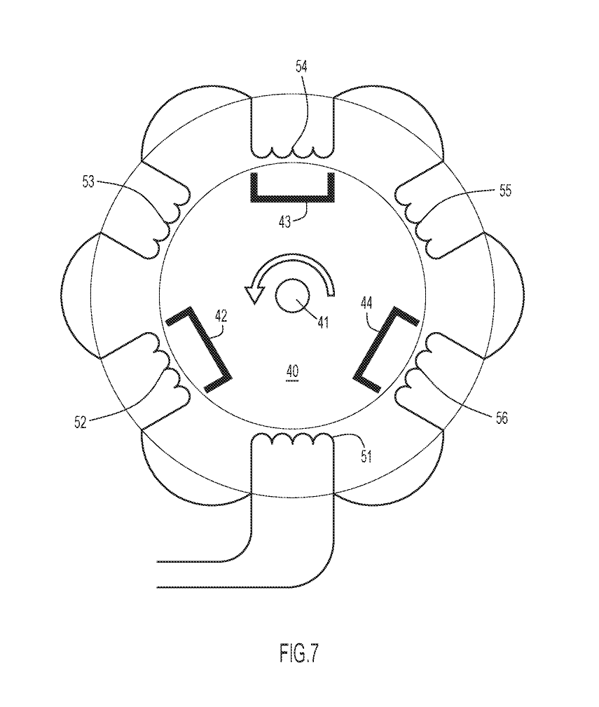

In an alternative embodiment the permanent magnet(s) need not be located on the axle of the spinner unit. For example, referring to FIG. 6, a spinner 30 may have a permanent magnet 34, 35, 36 on each spinner arm 31, 32, 33, respectively. The spinner 30 in this embodiment does not require an axle that rotates with the spinner arms but may be more like conventional fidget spinners in which the arms rotate relative to a central body portion with the aid of a ball bearing assembly as described in the aforementioned U.S. Pat. No. 9,914,063 (McCoskery). The central portion is fixedly secured to the outside surface of a wall of the charger housing if the charger is physically separable from devices containing a battery to be charged. In embodiments where the charger is structurally part of the device containing the battery, the central body portion of spinner 30 is secured to the outside surface of a wall of that device. In either case, the spinner arms 31, 32, 33 are free to rotate together about an axis comprising the central body portion, and the magnetic fields of permanent magnets 34, 35, 36 rotatably interact with one or more coils located inside the housing to which spinner 30 is secured as shown in FIG. 7.

Referring to FIG. 7, a spinner 40 is schematically illustrated as being rotatable about an axis 41 and having three permanent magnets 42, 43, 44 equally spaced angularly about axis 41. Magnets 42, 43, 44 corresponding, for example to magnets 34, 35, 36 of FIG. 6. Six coils 51, 52, 53, 54, 55, 56 are positioned peripherally about the magnets such that the field of each magnet induces an emf in each coil as that magnet rotates past that coil. The coils 51, 52, 53, 54, 55, 56 are electrically connected in series such that the output voltage induced in all of the coils is additive. That output voltage is applied across a voltage regulator circuit (for example the circuit of FIG. 5) from which a battery charging voltage is provided.

In the embodiments described herein, the spinners used to generate battery charging voltage have three radially extending arms that are symmetrically spaced 120° from one another. It will be appreciated that two, four, five, six or more arms may be provided without departing from the concepts of the present invention. Likewise, although having the arms equally angularly spaced is desirable, it is not a requirement for achieving the results described herein.

The material from which the spinners described herein are made is preferably a polymer or wood or non-magnetic metal (e.g., aluminum) so as to not interfere with the inductive conversion of the spinning energy of the magnets to the coils. The size of the spinners used with the present invention is determined by the convenience of a user being able to easily apply a flicking force to the spinner arms with a finger.

The invention provides a method and apparatus for charging a battery with a finger actuated low mass spinner, the mechanical spinning energy from which is electromagnetically converted to the desired battery charging voltage. The charger may be a self-contained portable battery charger unit for use with any of multiple devices containing respective batteries, or it may be a permanent part of such a device. The spinner may be a modified fidget spinner to which a shaft or axle is fixedly attached to rotate about that axis with the spinner and has one or more permanent magnets secured for rotation therewith. Alternatively the spinner may be more like the fidget spinner, without an axle rotating therewith, having magnets on its rotating arms. In either case, the magnetic fields of the rotating magnets induce voltage in one or more induction coils to generate a charging voltage.

Having described preferred embodiments of new and improved methods and apparatus for charging batteries in portable devices, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

I claim:

1. A battery charger comprising:
a finger-actuable spinner unit having plural radially extending arms configured to rotate about an axis in response to angularly directed finger flicks applied to one or more of said arms;
at least one inductive coil of electrically conductive wire;
at least one permanent magnet secured to said spinner unit and configured to rotate therewith about said axis, said magnet positioned relative to said coil so as to electromagnetically induce an AC voltage in said coil at an amplitude that varies with the speed of rotation of said spinner unit; and
a voltage regulator circuit for converting said induced AC voltage to a substantially constant DC voltage for charging a battery.

2. The battery charger of claim 1 wherein said spinner unit further comprises a shaft concentrically positioned on said axis and configured to rotate with said arms, and wherein said permanent magnet is secured to said shaft for rotation therewith.

3. The battery charger of claim 2 wherein said permanent magnet is secured to a disc configured to rotate with said shaft.

4. The battery charger of claim 1 wherein said at least one permanent magnet is secured to one of said arms.

5. The battery charger of claim 1 comprising a plurality of said permanent magnets, one each secured to a respective one of said arms.

6. The battery charger of claim 5 further comprising a plurality of said inductive coils, at least one each for each of said permanent magnets, wherein each permanent magnet is positioned relative to at least a respective one of said coils so as to electromagnetically induce an AC voltage in that coil at an amplitude that varies with the speed of rotation of said spinner unit.

7. The battery charger of claim 1 further comprising a self-contained portable unit having a housing defining an enclosure, wherein said spinner unit is mounted on a housing wall exteriorly of said enclosure, and said at least one coil and said voltage regulator circuit are located in said enclosure.

8. The battery charger of claim 7 wherein said at least one magnet is secured to one of said spinner arms externally of said enclosure.

9. The battery charger of claim 7 wherein said spinner unit further comprises a shaft concentrically positioned on said axis and configured to rotate with said arms, and wherein said permanent magnet is secured to said shaft for rotation therewith within said enclosure.

10. A method of charging a battery comprising
manually applying finger flick forces to radially extending arms of a finger-actuable spinner unit to rotate the spinner about an axis;
rotating at least one permanent magnet with said spinner unit to electromagnetically induce an AC voltage in at least one inductive coil;
rectifying and filtering said AC voltage to provide a DC charging voltage; and
applying said DC charging voltage to a battery.

11. The method of claim 10 wherein rotating said permanent magnet includes rotating a shaft with said spinner unit and securing said permanent magnet to said shaft for rotation herewith.

12. The method of claim 10 wherein rotating said permanent magnet includes securing said magnet to one of said radially extending arms.

13. The method of claim 10 wherein applying said DC charging voltage includes connecting a cable between a housing in which the AC voltage is induced and a device containing the battery.

14. The method of claim 10 wherein applying said DC charging voltage includes plugging a housing in which the AC voltage is induced directly into a device containing the battery.
